(19) United States
(12) Patent Application Publication
(10) Pub. No.: US 2007/0261077 A1
(43) Pub. Date: Nov. 8, 2007

(54) Using audio/visual environment to select ads on game platform

(76) Inventors: Gary Zalewski, Oakland, CA (US); Riley Russell, San Mateo, CA (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/430,593

(22) Filed: May 8, 2006

(51) Int. Cl. H04N 7/10; H04N 7/025

(52) U.S. Cl. 725/35; 725/34

(57) ABSTRACT

A method and system is provided for capturing audio/visual related information and selecting advertising based on the information.

### BACKGROUND OF THE INVENTION

Many video games contain advertising for products. For example, the advertising on the walls of a virtual racing game may comprise advertising for real products.

It would be advantageous if there were a system and method which selected advertising based on information relating to the user.

### SUMMARY OF THE INVENTION

One aspect of the invention provides a game console which includes a microphone, a camera, a processor and a memory that stores advertisements and instructions. The instructions include: storing sound received at the microphone and an image received at the camera; identifying information contained in the sound and image; selecting an advertisement for display based on the information; and rendering the advertisement. The stored image and sounds may be transmitted outside of the console for analysis, and the information received back into the console. The advertisements may also be male-oriented and female-oriented, so that the advertisement is selected based on the user's gender.

Another aspect of the invention provides a method comprising: receiving sound at a microphone; receiving an image at a camera; storing the sound and image in a memory; analyzing the sound and image to determine the characteristics of a user based on the sound and image; selecting an advertisement from a plurality of advertisements based on the characteristics, wherein the plurality of advertisements are based on different characteristics; and rendering the selected advertisement. The method may also include displaying characteristic-neutral content, such as a game, to the user before, during or after rendering the advertisement, such that the characteristic-neutral is content that was not selected based on the characteristics determined from the sound or image.

Yet a further aspect of the invention provides a method of selecting advertising. The method includes receiving an image and sound transmitted over a network from a computer; analyzing the image and sound to determine a characteristic associated with the environment surrounding the computer; selecting an advertisement based on the characteristic; and transmitting the advertisement to the computer.

A still further aspect of the invention involves receiving an image at a camera and a sound at a microphone, storing the image and sound in a memory and analyzing the image and sound to determine characteristics of a user or a user's environment based on the image.

Other aspects of the present invention are described below.

### BRIEF DESCRIPTIONS OF THE DRAWINGS

FIG. 1 is a functional diagram of a system in accordance with an aspect of the present invention.

FIG. 2 is a functional diagram of a system in accordance with an aspect of the present invention.

FIG. 3 is a diagram of a method in accordance with an aspect of the present invention.

FIG. 4 is a diagram of a method in accordance with an aspect of the present invention.

### DETAILED DESCRIPTION

The present application incorporates by reference U.S. patent application Ser. No. 11/400,997 entitled “System And Method For Obtaining User Information From Voices” that was filed Apr. 10, 2006, listing Eric Larsen and Ruxin Chen as inventors, and U.S. Provisional Patent Application No. 60/718,145 filed Sep. 15, 2005.

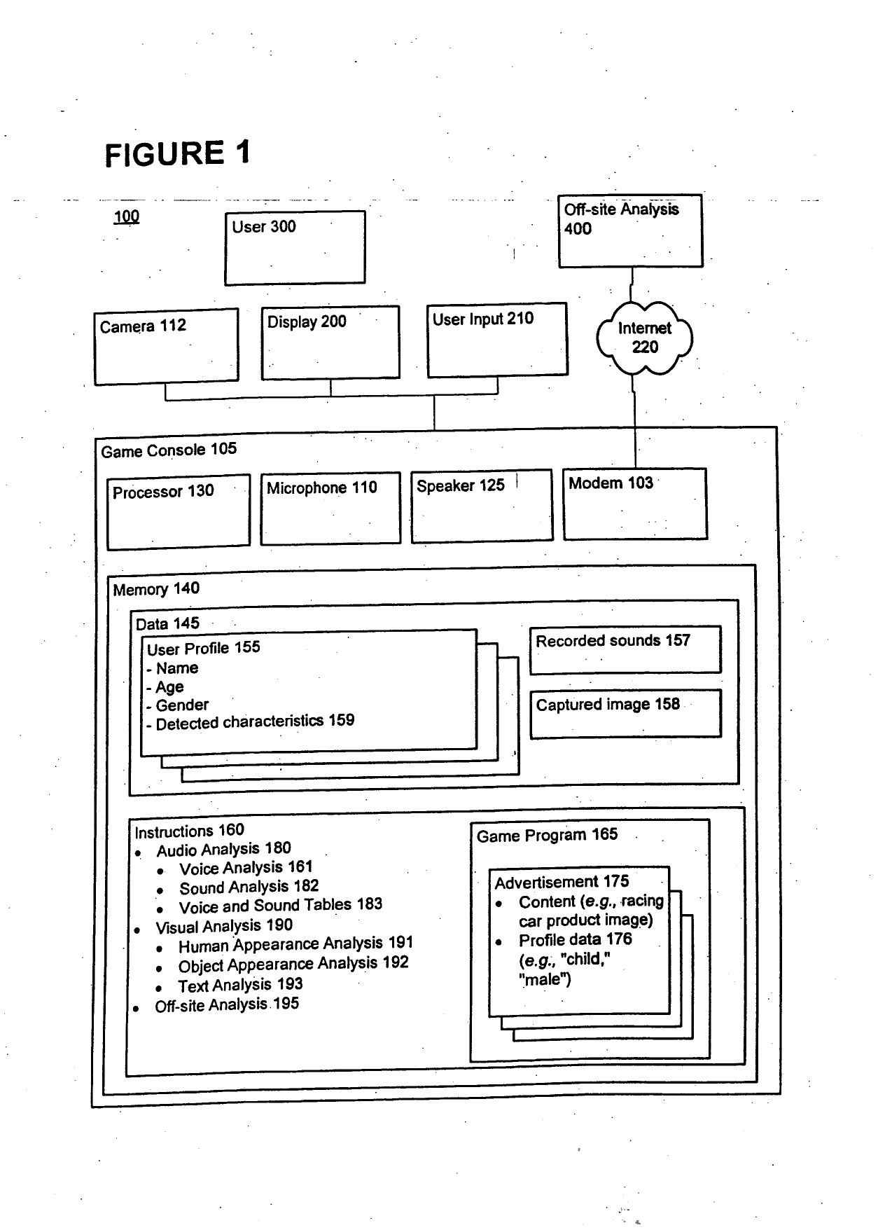

As shown in FIG. 1, a system 100 in accordance with one aspect of the invention comprises a game console 105, display 200, user input 210 and other components typically present in game consoles. The system is used by a user, indicated as user 300.

Game console 105 preferably includes a processor 130 and memory 140. Memory 140 stores information accessible by processor 130, including instructions 160 for execution by the processor 130, and data 145 which is retrieved, manipulated or stored by the processor. The memory may be of any type capable of storing information accessible by the processor; by way of example, hard-drives, ROM, RAM, CD-ROM, DVD, write-capable memories, and read-only memories.

The instructions 160 may comprise any set of instructions to be executed directly (e.g., machine code) or indirectly (e.g., scripts) by the processor. The terms “instructions,” “steps” and “programs” may be used interchangeably herein. The functions, methods and routines of the program in accordance with the present invention are explained in more detail below.

Data 145 may be retrieved, stored or modified by processor 130 in accordance with the instructions 160. The data may be stored in any manner known to those of ordinary skill in the art such as in computer registers, in records contained in tables and relational databases, or in XML files. The data may also be formatted in any computer readable format such as, but not limited to, binary values, ASCII or EBCDIC (Extended Binary-Coded Decimal Interchange Code). Moreover, any information sufficient to identify the relevant data may be stored, such as descriptive text, proprietary codes, pointers, or information which is used by a function to calculate the relevant data.

Although the processor and memory are functionally illustrated in FIG. 1 as within the same block, it will be understood by those of ordinary skill in the art that the processor and memory may actually comprise multiple processors and memories that may or may not be stored within the same physical housing. For example, some of the instructions and data may be stored on a removable CD-ROM and others within a read-only computer chip. Some or all of the instructions and data may be stored in a location physically remote from, yet still accessible by, the processor. Similarly, the processor may actually comprise a collection of processors which may or may not operate in parallel.

As noted above, system 100 may comprise additional components typically found in a game console or computer system such as a display 200 (e.g., an LCD screen), user input 210 (e.g., a keyboard, mouse, game pad, touch-sensitive screen), microphone 110, modem 103 (e.g., telephone or cable modem), camera 112, and all of the components used for connecting these elements to one another. Game console 105 preferably communicates with the Internet 220 via modem 103 or some other communication component such as a network card.

Instead of a game console, the system may also comprise any user device capable of processing instructions and transmitting data to and from humans and other computers or devices, including general purpose computers, network computers lacking local storage capability, PDA's with modems and Internet-capable and other wireless phones, digital video recorders, video-cassette records, cable television set-top boxes or consumer electronic devices.

In one aspect of the present invention, instructions 160 comprise a game program, such as a game stored on a DVD-ROM or downloaded to the console 105 via modem 105 from the Internet 220. Instructions 160 may also comprise routines stored within the console 105 which are accessible to, but not specific to, a particular game. For example, the console routines may be called by any game routine.

Preferably, at least a portion of the instructions 160 or data 145 comprises advertisements 175. The advertisements 175 may be any type of content that can be rendered, including data (e.g., images or sounds), instructions (e.g., “play product jingle”) or various combinations thereof.

At least some of the advertisements 175 are associated with advertising profile data 176. The advertising profile data 176 provides information which correlates the advertisement to particular classes of users or user environments. For example, if the advertisement relates to a racing car which is typically marketed to young boys, then the advertising profile data 176 may indicate a desired age range (“Child”) and a desired gender (“Male”). If the advertisement relates to a DVD about Beethoven, then the advertising profile data 176 may indicate desired music styles (“Classical”), interests (“audiophile”) and equipment (“DVD Player Owner.”). If the advertisement relates to dog food, then the advertising profile data 176 may be directed to users who own dogs or dog products. The profile data of some advertisements may indicate that the advertisements are directed to all users.

Some of the console routines preferably include audio analysis routines 180. These routines analyze audio signals and output information gleaned from the audio signals in response.

One of the audio analysis routines may comprise voice analysis routine 161. This routine analyzes recorded human speech and returns information about the user's characteristics to the extent those characteristics are reflected in the person's speech. For example, the routine may return values relating to the gender and age characteristics of the user detected in the recorded speech.

Thus, the value may indicate whether the user is likely to be male and female. It may also indicate the user's likely age, such as the age range reflected in the user's speech or whether the user has reached puberty.

Another audio analysis routine 180 may comprise sound analysis routine 182. This routine examines recorded audio for particular sounds, and outputs information regarding the sounds it recognized. For example, the routine may return the string value “dog bark” if the routine detects the presence of a dog bark. Thus, the user may be provided advertisements in connection with pet supplies.

Some of the console routines preferably include visual analysis routines 180. These routines analyze image information (such as still and moving images) and outputs information gleaned from the image signals in response.

One of the visual analysis routines 190 may comprise human visual appearance routine 191. This routine analyzes a user's visual appearance and returns information about the user's characteristics to the extent those characteristics are reflected in the image. For example, the returned information may indicate whether the user is likely to be male or female (e.g., based on hair style), the age range of the user (e.g., based on the person's size), and what the person is wearing, such as clothing and whether the user wears glasses.

Another visual analysis routine may include object appearance analysis routine 192. This routine attempts to identify particular objects, such as inanimate objects, appearing within an image. For example, the routine may look for, and return information indicating, whether a particular image includes a dog bowl. The presence of animate objects may also be detected, such as detecting the presence of a dog. In either event, identifying an object within the image may be associated with a corresponding characteristic, e.g., that the user has a dog.

Yet another visual analysis routine may include text analysis routine 193. This routine attempts to identify text within an image. For example, this routine may return information indicating the text written on a person's clothing, the spine of a book, a poster on a wall or a brand name on a product.

The foregoing audio and visual analysis routines are not limited to any particular method of analysis but, rather, may comprise any system and method known to those of ordinary skill in the art. For example, the fundamental frequency of a human's voice (often referred to as the person's “pitch”) is measurable, and it tends to vary based on gender, age and whether the person has gone through puberty. Voice analysis routine 161 may extract the fundamental frequency from human speech recorded in memory 140, compare the extracted frequency against a table of frequencies stored in memory 140 such as voice and sound table 183, determine the user's gender and age reflected in the user's speech, and then return a value indicative of that gender and age. Similarly, sound analysis routine 182 may search a recorded sound for the audio signals matching or resembling sound information stored in voice and sound table 183. Text analysis routine 193 may use optical character recognition (OCR) techniques.

Although significant advantages are presented if the console 105 contains analysis routines as described above, another aspect of the invention provides for the analysis to occur outside of the console. Instructions 160 may include one or more communication routines 195 which transmit visual information, audio information, or both to a remote processor or location for analysis. For example, the captured visual or audio information may be transmitted over the Internet 220 to off-site analysis system 400, which may comprise a server with a processor for processing the information and returning the values to the console 105. In an alternative embodiment of the invention, some or all of the captured visual or audio information is reviewed by humans, and values for selecting advertisements are transmitted back to the console. Off-site analysis system 400 may also transmit advertisements in lieu of values used to select advertisements.

Data 145 may also store user profiles 155. User profiles 155 contain information about the users that use the console 105. Some of the information may be provided by the user, such as the user's name. Other information may be derived form the captured audio information, video information or both. The user's profile may be specific to a particular user or applicable to all users.

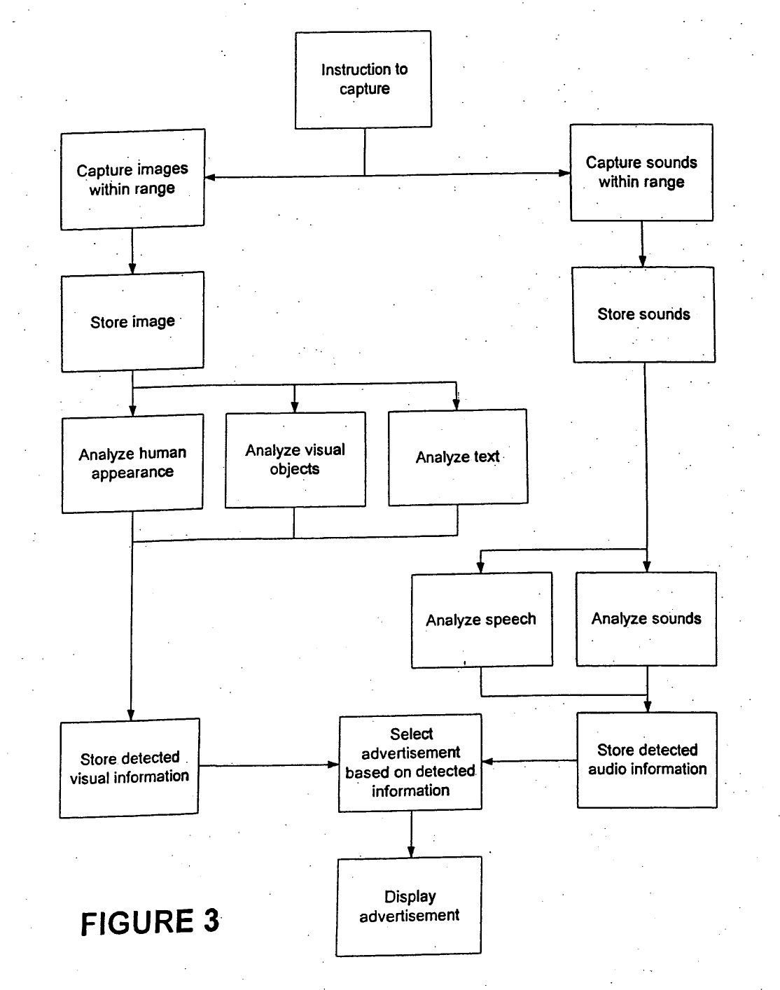

In addition to the operations illustrated in FIG. 3, an operation in accordance with a variety of aspects of the invention will now be described. It should be understood that the following operations do not have to be performed in the precise order described below. Rather, various steps can be handled in reverse order or simultaneously.

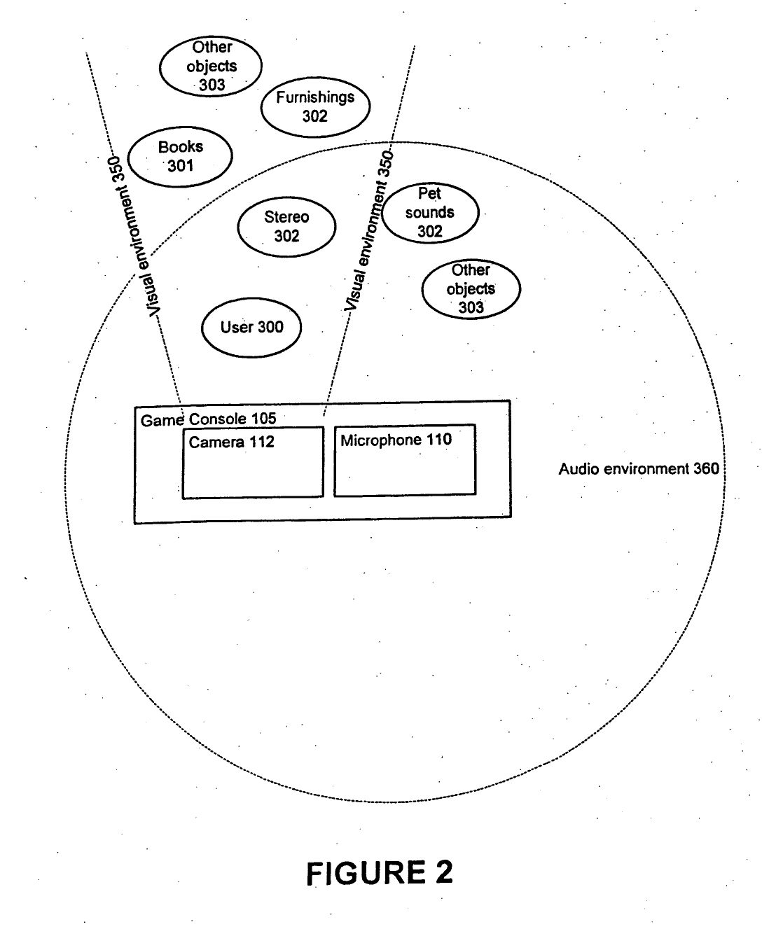

In accordance with instructions 160, the objects within the visual environment of the console 160 are analyzed. As functionally illustrated in FIG. 2, the visual environment may be analyzed by using camera 112 to capture a still or moving image of the objects within the field of view of camera 112. The visual objects may comprise the user 300 in front of the console or other objects within the camera's field of view, such as posters 300, books 301, furniture 302, and other objects 303. The images may be continuously captured and analyzed, or may be captured and analyzed upon certain events, such as every few minutes, upon the console 105 being powered on, upon the game program 165 being executed, or upon an instruction from the game.

In one example, the captured image 158 may be stored in data 145 for analysis by the visual analysis routines 190. The routines may analyze the visual information and output values representing the visual objects found, or estimates about the user 300 or the environment in which the console resides based on the visual objects. For example, the style of hair and clothing may be used to estimate gender (“male”, “female”); the physical size of user 300 may be used to estimate age (“child”, “adult”); the presence of a tie or buttons on a shirt may be used to estimate clothing preferences (“casual attire”, “business casual attire”, “business attire”); the brands appearing on clothing or furnishings (such as stereo 302) may be used to identify brand or entertainment preferences (“Sony”, “John Mayer”, “Spiderman”); the show or movies appearing on a television may be used to identify entertainment preferences (“Jeopardy”, “Spiderman”); the size of the room in which the console may be used may be evaluated (“large room”, “small room”); the titles of books 301 may be extracted to estimate reading preferences (“classics”, “fiction”); furnishings in the room may be used to estimate purchasing habits (“lamp”, “stereo”, “DVD player”, “personal computer”, “posters”, “oil painting”); and furniture style may be analyzed (“ornate furniture”, “modern furniture”). In one aspect of the invention, the analysis routines also ascribe values indicating the likelihood that the derived characteristic is accurate, for example, the likelihood that a user is female or the likelihood that a detected sound is a dog bark.

In accordance with instructions 160, the sound-emitting objects within the audio environment of the console 160 are analyzed. As functionally illustrated in FIG. 2, the audio environment 360 may be analyzed by using microphone 110 to capture sounds. Such sound-emitting objects may comprise the user 300 and other users near the console, as well as stereo 302, pet 302 and other sound-emitting objects 303. The sounds may be continuously captured and analyzed, or may be captured and analyzed upon certain events, such as every few minutes, upon the console 105 being powered on, upon the game program 165 being executed, or upon an instruction from the game.

The captured sounds 157 are then stored in data 145 for analysis by the audio analysis routines 180. By way of example, the routines may analyze the audio information, estimate information about the user or the surrounding environment from the audio information, and then output values representing those estimates as follows: the user's speech may be used to estimate gender and age (“male”, “female,” “child”, “adult”); the language and accent of the user's speech may be used to estimate where the user grew up (“Southern USA”, “Japan”); the music playing on a stereo 302 may be used to identify music preferences (“John Mayer”, “classical”), and the mere fact that music is playing may be used to estimate whether the user likes music (“audiophile”, “prefers silence”); the show or movies playing on a television may be used to identify entertainment preferences (“Jeopardy”, “Spiderman”); and the sound of pets 302 may be used to determine pet ownership (“dog”, “cat”).

The detected audio and visual characteristics 159 may be stored in the user's profile 155. In addition to storing the most-recently derived information, a running total of detected characteristics may also be kept to increase the accuracy of the derived information (e.g., detecting “male” detected ten times and “female” makes it more likely that the user is female).

Instructions 160, such as a game program 165, or software in a DVR, cable TV set-top box or consumer electronic device may use the detected characteristics 159 to select advertising 175. Some or all of the advertising may be selected based on the profile data 176 associated with the advertisements and the detected characteristics 159 stored in user profile 155. For example, a racing game 165 may include at least two advertisements 175 to be displayed on the walls surrounding a racetrack: one ad shows a dump truck and its profile data is “male” and “child”; another ad is for a calcium supplement and its profile is “female” and “adult;” yet another ad is for a Beethoven DVD and its profile is “classical music preference” and “DVD player owner.” When game program 165 needs to select an advertisement for display, it compares the advertisement profile data 176 against the detected characteristics 159 and selects an advertisement 175 based thereon. Using the foregoing example, if the detected characteristics include only “male” and “child,” the game program 165 would select the dump truck ad and display the ad on the racing track wall. Preferably, the game program 165 selects the advertisement which has the greatest match between the advertisement's profile data and the detected characteristics.

Preferably, the advertising does not interrupt the game experience but, rather, is incorporated into the game experience. The advertising may be displayed to the user by interrupting the game and showing the advertising. Preferably, however, the advertising is incorporated into the game, such as on the racetrack walls of a racing game, the side of building in another game, or as objects (such as Beethoven DVD) that the user can pick up and interact with in a simulation. Thus, the advertising may be displayed with content that it is unrelated to either the user's characteristics or the selected advertisement.

The present invention provides at least three separate and unique aspects. One aspect relates to the analysis of sound-emitting objects to determine information about the environment which enhances the selection of in-game advertising. Another aspect relates to the analysis of visually-perceptible objects to determine information about the environment which enhances the selection of in-game advertising.

Yet another system uses both audio and visual information to detect characteristics about the user and the console's environment to select in-game advertising. This last system is particularly advantageous because it allows the audio and visual information to be used in synergistically unique ways. For example, the characteristics detected from the visual environment may indicate the presence of books on Beethoven, and the object analysis routine may output a value indicating that there is thus a 30% likelihood that the current user enjoys Beethoven. This likelihood may not be sufficient to show an advertisement for Beethoven CD's in a racing game. However, the characteristics detected from the audio environment may indicate that classical music is playing, and the object analysis routine may output a value indicating that there is thus a 60% likelihood that the current user enjoys classical music. Instructions 160 may include rules indicating that combination of these two detected characteristics—Beethoven books and classical music playing—are sufficient to show a Beethoven advertisement even though each characteristic alone is not sufficient. Moreover, by using both audio and visual characteristics, the inherent limitations that are uniquely associated with each may be overcome by the other.

Differences between detected characteristics may also be used during advertising selection. For example, if the audio analysis routines 180 indicate that the user is male and the visual analysis routines indicate that the user is female, then instructions 160 may select gender-neutral rather than gender-specific content. Alternatively, in the event conflicting characteristics are detected, the instructions may select the characteristic with the greater likelihood of applying to the user.

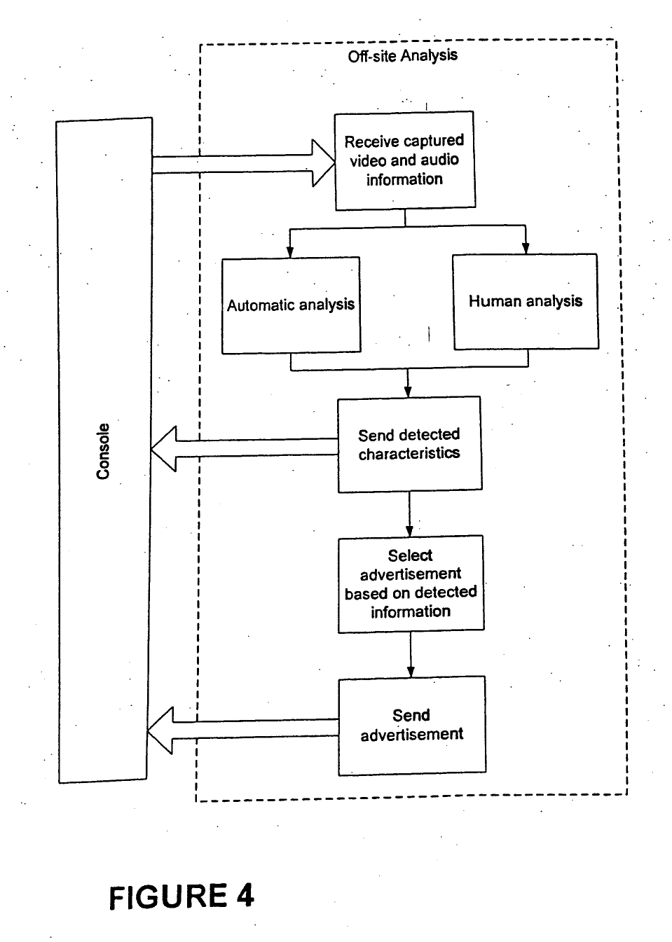

To the extent the console 105 lacks the capability of detecting various characteristics, and as functionally illustrated in FIG. 4, the recorded sounds 157 and captured image 158 may be transmitted to the off-site analysis system 400 via modem 103 and Internet 200 for further review. For example, instructions 160 and data 145 may contain enough information to determine whether the user is likely male or female based on voice. However, the console 105 may not contain sufficient processing power or information to determine whether the user is male or female based on visual appearance. It may also lack sufficient processing power or information to determine the type of music playing in the background. The off-site analysis system 400 may analyze the provided audio and visual information and return detected characteristics to game console 105. Although particular advantages are attained when the information is automatically evaluated with the use of computer processors, some or all of the detected characteristics may also be determined by the use of humans listening or watching the information. In the regard, in one aspect of the present invention, a method and system is provided whereby audio and visual information is processed both internally within a game console and externally at a remote geographic location so as to detect characteristics about the user or the user's environment.

Rather than transmitting the detected characteristics, the off-site analysis system 400 may also transmit advertising content to console 105 for use by game program 165.

System 100 may also include devices and methods for ignoring certain sounds. For example, sounds emitted in accordance with game program 165, DVR, TV etc. may be subtracted from the recorded sounds 157 so that these sounds are not mistakenly attributed to the audio environment 360.

Another aspect of the invention enhances the foregoing by also using the audio and/or visual environment to identify the actual user. For example, the user profile may include a phrase recorded by the user. When the user starts the console or the game, the system not only extracts the user's maturity level from a spoken phrase, but also uses the spoken phrase to identify the user and his or her profile. By further way of example, the user profile may also include a picture of the user's face or other information, and the image of the user's face that was captured by the camera is used to identify the user and his or her profile. Preferably, both the audio and the visual information is used to identify the user.

Most of the foregoing alternative embodiments are not mutually exclusive, but may be implemented in various combinations to achieve unique advantages. As these and other variations and combinations of the features discussed above can be utilized w ithout departing from the invention as defined by the claims, the foregoing description of the embodiments should be taken by way of illustration rather than by way of limitation of the invention as defined by the claims.

1. A game console comprising:
a microphone;
a camera;
a processor;
a memory storing advertisements and instructions, the instructions comprising: storing sound received at the microphone and an image received at the camera; identifying information contained in the sound and image; selecting an advertisement for display based on the information; and
rendering the advertisement.

2. The game console of claim 1 further comprising a modem, and wherein the instructions further comprise transmitting the stored image outside of the console for analysis and receiving the information.

3. The game console of claim 1 further comprising a modem, and wherein the instructions further comprise transmitting the stored sound outside of the console for analysis and receiving the information.

4. The game console of claim 1 further comprising a modem, and wherein the instructions further comprise transmitting the stored image and sound outside of the console for analysis and receiving the information.

5. The game console of claim 1 wherein the information is related to the user's gender.

6. The game console of claim 4 wherein the advertisements comprise a male-oriented advertisement and a female oriented-advertisement, and the advertisement is selected based on the user's gender.

7. The game console of claim 1 wherein the information is related to the user's age.

8. A method comprising
receiving sound at a microphone;
receiving an image at a camera;
storing the sound and image in a memory;
analyzing the sound and image to determine the characteristics of a user based on the sound and image;
selecting an advertisement from a plurality of advertisements based on the characteristics, wherein the plurality of advertisements are based on different characteristics; and
rendering the selected advertisement.

9. The method of claim 8 further comprising displaying characteristic-neutral content to the user before and after rendering the advertisement, wherein characteristic-neutral comprises content that was not selected based on the characteristics determined from the sound or image.

10. The method of claim 9 further comprising displaying characteristic-neutral content to the user while rendering the advertisement.

11. The method of claim 10 wherein the characteristic-neutral content comprises an interactive game.

12. The method of claim 11 wherein the characteristics comprise the identity of objects within the camera's field of view and range of the microphone.

13. The method of claim 9 wherein the image is a moving image.

14. A method of selecting advertising comprising:
receiving an image and sound transmitted over a network from a computer;
analyzing the image and sound to determine a characteristic associated with the environment surrounding the computer;
selecting an advertisement based on the characteristic;
transmitting the advertisement to the computer.

15. The method of claim 14 wherein the computer is a game console.

16. A method comprising
receiving an image at a camera and a sound at a microphone;
storing the image and sound in a memory;
analyzing the image and sound to determine characteristics of a user or a user's environment based on the image.
